(19) United States
(12) Patent Application Publication
(10) Pub. No.: US 2026/0320439 A1
(43) Pub. Date: Oct. 15, 2026

(54) COMPUTING DEVICE, COMPUTING SYSTEM, AND OPERATING METHOD OF COMPUTING SYSTEM

(71) Applicant: SK hynix Inc., Icheon-si (KR)

(72) Inventor: Myung Hyun RHEE, Icheon-si (KR)

(21) Appl. No.: 19/562,083

(22) Filed: Mar. 10, 2026

(30) Foreign Application Priority Data
Apr. 10, 2025 (KR) 10-2025-0046470
Dec. 1, 2025 (KR) 10-2025-0186570

(51) Int. Cl. G06N 5/04; G06F 16/2455

(52) U.S. Cl. CPC G06N 5/04; G06F 16/24552

(57) ABSTRACT

An artificial intelligence inference computing architecture separates attention processing using a shared key-value cache reused across multiple user sessions from attention processing using user-specific key-value caches, where a first computing node performs a first attention operation based on the shared cache and a second computing node performs a second attention operation based on a user key-value cache generated according to a received query, thereby improving throughput and resource utilization of a computing system performing inference.

### CROSS-REFERENCE TO RELATED APPLICATIONS

The present application claims priority under 35 U.S.C. 119(a) to Korean patent application number 10-2025-0046470 filed on Apr. 10, 2025, and Korean patent application number 10-2025-0186570 filed on Dec. 1, 2025, which are incorporated herein by reference in its entirety.

### BACKGROUND

The embodiments of the present disclosure relate to a computing device, a computing system, and an operating method of a computing system for an artificial intelligence inference architecture.

A computing device may include a processor that performs calculations or operations and a memory that stores data used when the processor performs the calculations or operations. The processor may store data required for the calculations in the memory, read the data stored in the memory to perform the calculations, and store data based on the calculation results in the memory.

Depending on the calculations or operations performed by the processor, the amount of data transferred between the processor and the memory may increase. When performing learning or inference operations for an artificial intelligence model, the amount of data transferred may further increase, which may result in the processor's computational performance not being fully utilized, resulting in a problem of deteriorating the operating performance of the computing device.

Conventional approaches for improving reliability in artificial intelligence inference include retrieval augmented generation (RAG), in which documents are retrieved at query time and used as grounding context. However, RAG can introduce retrieval latency, document selection errors, and increased system complexity due to retrieval pipelines and index management.

An alternative approach is cache augmented generation (CAG), in which domain knowledge is preserved in a key-value cache rather than retrieved during inference. However, applying transformer attention over extremely long cached data (e.g., tens of millions of tokens) is computationally expensive and memory-bound. Further, maintaining independent key-value caches for each user results in poor GPU utilization and high cost.

### SUMMARY

The tasks of the embodiments of the present disclosure are not limited to the tasks mentioned in this disclosure, and other tasks not mentioned will be clearly understood by those skilled in the art from the description below.

Embodiments of the disclosure may provide a method for improving the efficiency of inference operations using artificial intelligence models and enhancing the operating performance of a computing device and system that perform operations using artificial intelligence models.

Embodiments of the present disclosure may provide a computing system including a first computing node configured to store at least one shared key-value cache shared among a plurality of queries associated with different user sessions, perform a first attention operation based on a received query and the at least one shared key-value cache, and output a first operation value calculated according to the first attention operation, and a second computing node configured to store a user key-value cache generated according to the received query, perform a second attention operation based on at least one of the received query or the first operation value and the user key-value cache, and provide a second operation value calculated according to the second attention operation.

Embodiments of the present disclosure may provide a computing device including a first processing unit including a first memory that stores at least one shared key-value shared among a plurality of queries associated with different user sessions and a first processor that performs a first attention operation based on a received query and the at least one shared key-value cache and outputs a first operation value, and a second processing unit including a second memory that stores a user key-value cache generated according to the received query and a second processor that receives the first operation value and performs a second attention operation based on the first operation value and the user key-value cache to provide a second operation value.

Embodiments of the present disclosure may provide an operating method of a computing system, including receiving a query, performing a first attention operation based on the query and a shared key-value cache by a first processing unit storing the shared key-value cache shared among a plurality of queries associated with different user sessions, and outputting a first operation value, and performing a second attention operation based on the first operation value and a user key-value cache by a second processing unit storing the user key-value cache generated according to the query and outputting a second operation value.

According to embodiments of the present disclosure, a node storing a shared key-value cache and a node storing a user key-value cache may be separated and an operation using the key-value cache may be performed by a separate processor, thereby improving the efficiency of operations of an artificial intelligence model performed using the key-value cache and enhancing the operating performance of a computing device and system.

The effects of the embodiments of the present disclosure are not limited to the described effects, and other effects not mentioned will be clearly understood by those skilled in the art from the description of the claims.

### BRIEF DESCRIPTION OF THE DRAWINGS

The present disclosure will be more fully understood from the detailed description and accompanying drawings provided below, which are provided for illustration purposes only and are not intended to limit the present disclosure.

FIG. 1 illustrates an example of a schematic configuration of a computing device according to embodiments of the present disclosure.

FIG. 2 illustrates an example of a schematic configuration of a computing system according to embodiments of the present disclosure.

FIG. 3 illustrates an example of the operation method of the computing system illustrated in FIG. 2.

FIG. 4 illustrates an example of a computation method using an artificial intelligence model performed by a computing system according to embodiments of the present disclosure.

FIGS. 5 and 6 illustrate an example of the operation of a computing system according to the computation method illustrated in FIG. 4.

FIGS. 7 and 8 illustrate another example of a schematic configuration of a computing system according to embodiments of the present disclosure.

FIG. 9 illustrates an example of an operating method of a computing system according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, manufacturing methods, these terms may be used to describe non-consecutive or non-sequential processes or operations unless the term "directly" or "immediately" is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

Embodiments of the present disclosure relate to computing systems, computing devices, and methods for performing attention operations in artificial intelligence inference using a shared key-value cache reused across multiple user sessions and user-specific key-value caches generated for individual queries. By separating attention processing of the shared key-value cache from attention processing of the user-specific key-value caches, the computing system can improve efficiency and throughput of artificial intelligence inference operations.

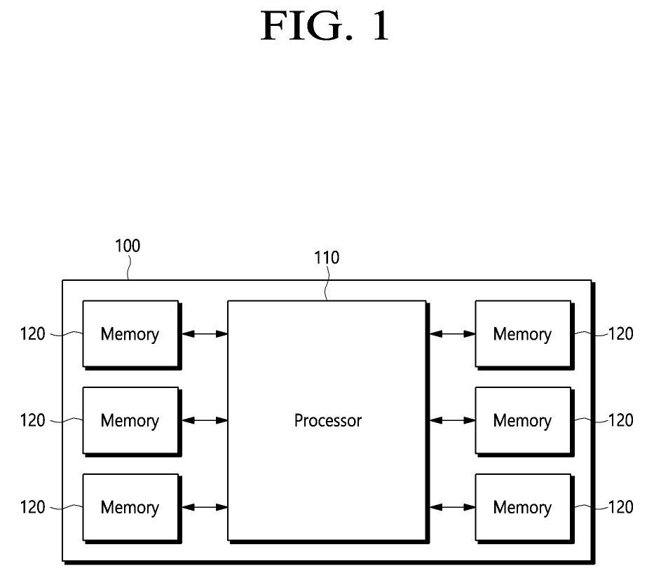

FIG. 1 illustrates an example of a schematic configuration of a computing device 100 according to embodiments of the present disclosure.

Referring to FIG. 1, the computing device 100 may include at least one processor 110. The computing device 100 may include at least one memory 120. The processor 110 may communicate with the memory 120 and perform operations using data stored in the memory 120. The processor 110 may store result data generated according to the operations in the memory 120. The processor 110 and the memory 120 may be collectively referred to as a processing unit. The computing device 100 may also include a plurality of processing units.

The processor 110 may be, for example, a graphics processing unit (GPU), a neural network processing unit (NPU), a tensor processing unit (TPU), or a data processing unit (DPU), but is not limited thereto. In some cases, the processor 110 may also be a central processing unit (CPU). The processor 110 may be one of various xPUs that perform data processing or various operations.

The processor 110 may perform various data processing or operations under the control of the corresponding processor 110. Alternatively, the processor 110 may perform various data processing or operations under the control of another processor 110 located externally. The other processor 110 located externally may be referred to as a host or a host device.

The processor 110 and memory 120 may be arranged on a printed circuit board or an interposer positioned on the printed circuit board. The processor 110 and memory 120 may communicate with each other through wiring included in or arranged on the interposer. The processor 110 may communicate with a device located external to the computing device 100 through wiring arranged on the interposer and the printed circuit board.

The memory 120 may be connected only to wiring that communicates with the processor 110, or, in some cases, may communicate with an external device through an interposer or a printed circuit board.

The memory 120 may be, for example, a volatile memory such as DRAM, SDRAM, DDR SDRAM, GDDR SDRAM, LPDDR, etc., but is not limited thereto. The memory 120 may be a high bandwidth memory (HBM) implemented by stacking multiple volatile memories. Alternatively, the memory 120 may include heterogeneous volatile memories. Two or more types of volatile memories may be arranged in the computing device 100.

Alternatively, the memory 120 may be a non-volatile memory, depending on the case. The memory 120 may be, but is not limited to, NAND flash memory, 3D NAND flash memory, phase change memory, magnetoresistive memory, resistive change memory, SOM (Selector-Only-Memory), etc. In addition, the memory 120 may be a high bandwidth flash (HBF) or high bandwidth storage (HBS) in which NAND flash memory or 3D NAND flash memory is stacked.

In some cases, some of the memory 120 included in the computing device 100 may be volatile memory, while others may be non-volatile memory. In such cases, the volatile memory and non-volatile memory may be arranged on separate dies, interposers, or printed circuit boards, or may be arranged on the same dies, interposers, or printed circuit boards. Controllers that control the operations of the volatile memory and non-volatile memory may be arranged separately, or may be implemented and arranged as an integrated unit.

The memory 120 may include memory cells that store data. The memory 120 may include various control circuits for controlling the operations of the memory cells. The memory 120 may, in some cases, include logic circuits that perform operations according to a command from the processor 110. The memory 120 includes logic circuits that perform operations and may support at least some of the operations performed by the processor 110. In an embodiment, the memory 120 may store key-value caches that represent intermediate computational states generated during inference operations of an artificial intelligence model. The key-value caches stored in memory 120 may have varying sizes depending on the length of the context they represent, ranging from thousands of tokens for user-specific contexts to millions of tokens for domain-specific shared contexts.

The processor 110 of the computing device 100 may perform various operations or data processing using the memory 120. The processor 110 may perform operations for learning or training an artificial intelligence model.

Alternatively, the processor 110 may perform inference operations based on the artificial intelligence model. The processor 110 may perform operations using the artificial intelligence model based on a query input from outside and provide result data according to the operations. Parameters used in performing operations using the artificial intelligence model or key-value caches generated during the operations may be stored and used in the memory 120. In an embodiment, the key-value cache stores key vectors and value vectors computed from input tokens, which are reused during attention operations to avoid redundant computation.

The data used in operations related to the artificial intelligence model may vary, and the method of storing the data may also vary. In some cases, the data used for operations related to the artificial intelligence model may be stored in a plurality of computing devices 100. The plurality of computing devices 100 may constitute a computing system.

A computing system may perform operations related to an artificial intelligence model using a processor 110 and memory 120 included in each of a plurality of computing devices 100. Each computing device 100 included in the computing system may be configured to efficiently perform operations for an artificial intelligence model.

For example, the types of an operation performed by each computing device 100 or the data stored in each computing device 100 may be different. The efficiency of the operations performed by the plurality of computing devices 100 can be improved by distinguishing the operations and related data performed by each computing device 100. In an embodiment, attention operations using key-value caches may exhibit different computational characteristics depending on whether the key-value cache is shared across multiple queries associated with different user sessions or is user-specific. By recognizing these different characteristics and allocating computing resources accordingly, for example by separating processing of shared key-value caches from processing of user-specific key-value caches, the computing system can optimize overall throughput and resource utilization.

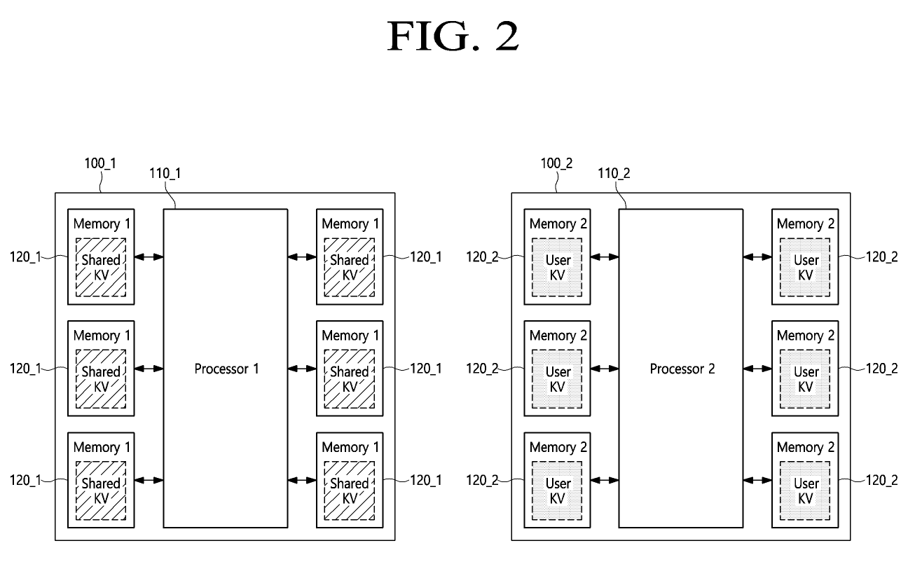

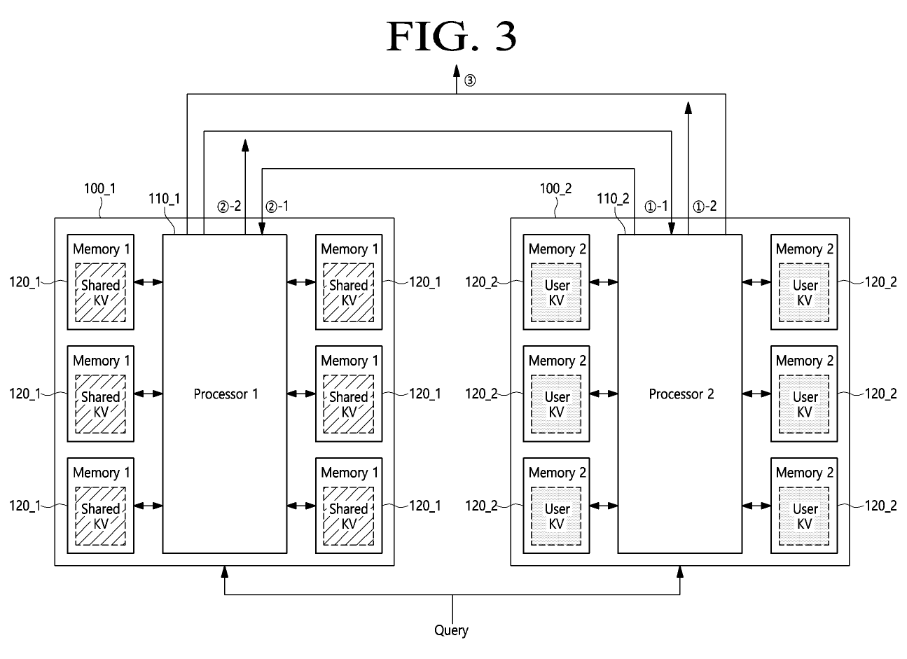

FIG. 2 illustrates an example of a schematic configuration of a computing system according to embodiments of the present disclosure, and FIG. 3 illustrates an example of the operating method of the computing system illustrated in FIG. 2.

Referring to FIG. 2, the computing system may include a plurality of computing devices 100. Each of the plurality of computing devices 100 may include at least one processor 110 and at least one memory 120. FIG. 2 illustrates an example in which the computing system includes a first computing device 100_1 and a second computing device 100_2, but the present embodiments are not limited thereto.

The first computing device 100_1 may include a first processor 110_1 and a first memory 120_1. The second computing device 100_2 may include a second processor 110_2 and a second memory 120_2. The first computing device 100_1 and the second computing device 100_2 may perform various operations based on requests received from an external source. For example, a first computing device 100_1 and a second computing device 100_2 may perform operations in response to requests received from an external host device.

A computing system may be defined as including a first computing device 100_1, a second computing device 100_2, and a host device. In this specification, the first computing device 100_1 may be referred to as a first computing node, and the second computing device 100_2 may be referred to as a second computing node. In some cases, a unit including the first processor 110_1 and the first memory 120_1 may be referred to as a first processing unit, and a unit including the second processor 110_2 and the second memory 120_2 may be referred to as a second processing unit. The first processing unit and the second processing unit may constitute a single computing device 100. Accordingly, the terms "computing node," "computing device," and "processing unit" may be used to describe different levels of system organization, depending on the implementation. A processing unit may correspond to a basic computational element (e.g., a processor and memory), a computing device may include one or more processing units, and a computing node may correspond to one or more computing devices and/or processing units logically configured to perform a common function such as shared key-value attention or user key-value attention.

The first computing device 100_1 and the second computing device 100_2 may perform operations using an artificial intelligence model in response to a request from the host device. The first computing device 100_1 and the second computing device 100_2 may perform operations for learning an artificial intelligence model, or may perform inference operations using a learned artificial intelligence model. The first computing device 100_1 and the second computing device 100_2 may perform the same or different operations when performing inference operations for an artificial intelligence model.

For example, the first computing device 100_1 and the second computing device 100_2 may receive a query from an external source and perform an inference operation using the received query and a pre-stored artificial intelligence model. The first computing device 100_1 and the second computing device 100_2 may store various parameters according to the learned artificial intelligence model. The first computing device 100_1 and the second computing device 100_2 may perform an inference operation using the received query and the pre-stored parameters.

The inference operation may be performed on a multi-layer basis, and a linear and attention operation may be performed on each layer. For example, multiple linear operations and at least one attention operation may be performed in each layer.

The first computing device 100_1 and the second computing device 100_2 may perform at least some of the linear operations and attention operations, and output result data produced by performing the operations.

The first computing device 100_1 and the second computing device 100_2 may store and use a plurality of key-value caches used in the process of performing artificial intelligence inference operations . A key-value cache may refer to a collection of key vectors and value vectors corresponding to one or more tokens and used in an attention operation. For example, an attention operation may be performed by applying the key-value cache to a query vector derived from a query, and output data of the attention operation may be provided as an intermediate result value or a final result value. The first computing device 100_1 and the second computing device 100_2 may store the same type of key-value cache to perform the inference operation, or may store different types of key-value caches to perform the inference operation.

For example, as illustrated in FIG. 2, the first computing device 100_1 may store a shared key-value cache. The shared key-value cache may refer to a key-value cache that is pre-computed from domain-specific knowledge and is reused across multiple queries from different users when performing attention operations. For example, the shared key-value cache may include pre-computed key vectors and value vectors derived from curated domain knowledge in specific fields such as law, medicine, science, and technology (including, e.g., peer-reviewed scientific publications, engineering textbooks, technical standards, semiconductor process specifications, circuit design documentation, and communication protocol specifications), and may be used to process input queries related to the specific field. Unlike conventional key-value caches that are generated dynamically for each user session, the shared key-value cache is computed in advance from domain knowledge and persists across user sessions, functioning in some respects similarly to model parameters in that it represents fixed knowledge that is reused across user sessions and applied during attention operations for queries associated with the corresponding domain.

The shared key-value cache may be stored in a first memory 120_1 included in the first computing device 100_1. A shared key-value cache corresponding to the same field may be stored in all first memories 120_1 of the first computing device 100_1. A shared key-value cache corresponding to the same field may be stored in memories 120 included in a plurality of computing devices 100.

Alternatively, a shared key-value cache corresponding to a first field may be stored in some first memories 120_1 of the first computing device 100_1, and a shared key-value cache corresponding to a second field may be stored in other first memory 120_1. The form in which the shared key-value cache is stored in the first computing device 100_1 may vary, and a plurality of first computing devices 100_1 may perform operations using an artificial intelligence model while storing at least a portion of the shared key-value cache. In an embodiment, the shared key-value cache may be long, representing tens of millions of tokens of domain knowledge, and may be divided into chunks for storage and processing. Each chunk may represent a coarse-grained unit of the shared key-value cache, for example including key vectors and value vectors corresponding to approximately one million to four million tokens. The coarse-grained chunking reduces routing overhead and minimizes the risk that routing decisions will exclude necessary information.

For example, the first processor 110_1 of the first computing device 100_1 may perform an inference operation using the received query and the shared key-value cache stored in the first memory 120_1. The inference operation may refer to a matrix operation on the query and the shared key-value cache. An intermediate value or a final value according to the query may be produced through the inference operation. In an embodiment, the attention operation may compute attention scores between query vectors derived from the input query and key vectors in the shared key-value cache, and generate an output value based on the attention scores and corresponding value vectors.

Since the first processor 110_1 performs an operation using the shared key-value cache for a query corresponding to a specific field, the first processor may simultaneously perform operations using a plurality of queries and a shared key-value cache. Since the shared key-value cache is an operation value commonly applied to a plurality of queries corresponding to a specific field when performing an inference operation using an artificial intelligence model, operations for a plurality of queries may be performed simultaneously and result values may be provided. This simultaneous processing of multiple queries against the same shared key-value cache may be referred to as multi-batch shared key-value attention. In multi-batch shared key-value attention, query vectors from multiple different queries are batched and processed concurrently against the same shared key-value cache, thereby increasing operational intensity and improving GPU utilization and throughput.

The second computing device 100_2 may store a different type of key-value cache than the first computing device 100_1. The second computing device 100_2 may, for example, store a user key-value cache. The user key-value cache may also be referred to as an individual key-value cache.

The user key-value cache may refer to a key-value cache based on an externally input query (or received query). The user key-value cache may, for example, be a key-value cache generated based on a received query. The user key-value cache may be used in subsequent operations for the query. In an embodiment, unlike the shared key-value cache which is pre-computed and reused across multiple users, the user key-value cache is dynamically generated during the inference operation based on the specific query and conversation history of an individual user session. The user key-value cache stores the key and value vectors computed from the user's specific prompt, conversation context, and any user-specific information that is not part of the shared domain knowledge.

In response to receiving a query from the outside, the first computing device 100_1 and the second computing device 100_2 may perform an operation using a shared key-value cache and an operation using a user key-value cache for the query.

For example, the first computing device 100_1 and the second computing device 100_2 may perform an attention operation using a query and a pre-stored key-value cache. The first computing device 100_1 may perform a first attention operation using a query and a shared key-value cache. The second computing device 100_2 may perform a second attention operation using a query and a user key-value cache.

The first attention operation using a shared key-value cache and the second attention operation using a user key-value cache may be performed by separate computing devices 100. Since the operations using the shared key-value cache are centrally processed by some computing devices 100, the efficiency of the operations using the shared key-value cache can be improved. In addition, the computing performance and communication performance of the computing devices 100 performing the operations using the shared key-value cache and the computing devices 100 performing the operations using the user key-value caches may be different.

For example, the computational performance value of the first processor 110_1 included in the first computing device 100_1 performing the first attention operation using the shared key-value cache may be greater than the computational performance value of the second processor 110_2 included in the second computing device 100_2 performing the second attention operation using the user key-value cache, such that the first processor 110_1 provides relatively higher arithmetic throughput for the first attention operation. A bandwidth of the second memory 120_2 included in the second computing device 100_2 performing the second attention operation using the user key-value cache may be greater than or equal to a bandwidth of the first memory 120_1 included in the first computing device 100_1 performing the first attention operation using the shared key-value cache, such that the second memory 120_2 provides relatively higher data transfer bandwidth for accessing user-specific key-value caches. In an embodiment, the computational performance value may be measured in terms of floating-point operations per second (FLOPS), tensor operations per second, or other metrics indicating the rate at which the processor can perform arithmetic computations. The bandwidth may be measured in terms of data transfer rate between the memory and the processor, such as gigabytes per second. [ADDED TO PROVIDE SUPPORT FOR CLAIMS 5 AND 15]

The computational performance of the first computing device 100_1 performing the operation using the shared key-value cache may be provided higher, and the bandwidth of the second memory 120_2 used in the second computing device 100_2 performing the operation using the user key-value cache may be provided higher. Since the performance of the computing device 100 is provided according to the characteristics of the attention operation using each key-value cache, the operating performance of the computing system performing the attention operation using the shared key-value cache and the user key-value cache can be improved.

The first computing device 100_1 and the second computing device 100_2 may perform attention operations on queries received from the outside, share the result values from the attention operations, and perform operations using an artificial intelligence model.

For example, referring to FIG. 3, the first computing device 100_1 and the second computing device 100_2 may receive a query from the outside. Each of the first computing device 100_1 and the second computing device 100_2 may perform an attention operation on the received query.

The first memory 120_1 of the first computing device 100_1 may store a shared key-value cache. The first processor 110_1 of the first computing device 100_1 may perform a first attention operation using the received query and the shared key-value cache.

The second memory 120_2 of the second computing device 100_2 may store a user key-value cache. The second processor 110_2 of the second computing device 100_2 may perform a second attention operation using the received query and the user key-value cache. Alternatively, the second processor 110_2 may perform the second attention operation using the received query and previously stored parameters. The second processor 110_2 may generate a user key-value cache through the aforementioned operation. The second processor 110_2 may store the user key-value cache in the second memory 120_2. The second processor 110_2 may perform a second attention operation using the stored user key-value cache and the received query.

The result values resulting from the operations performed by the first computing device 100_1 and the second computing device 100_2 may be shared. Additional operations may be performed on the result values and provided to an external device (e.g., a host device).

For example, as in ①-1, the first attention operation may be performed based on a query received by the first processor 110_1 and the previously stored shared key-value cache. The intermediate value generated according to the first attention operation may be provided to the second computing device 100_2.

The second processor 110_2 may perform the second attention operation using the received intermediate value and the previously stored user key-value cache. The second processor 110_2 may provide the result value according to the second attention operation to the outside, as in ①-2.

As another example, a second attention operation may be performed based on a query received by the second processor 110_2 and a user key-value cache, as in ②-1. The second processor 110_2 may perform the second attention operation based on the query and parameters of the artificial intelligence model and generate a user key-value cache. The second processor 110_2 may perform the second attention operation based on the generated user key-value cache and the query. The second processor 110_2 may perform at least one second attention operation. An intermediate value generated by the second attention operation may be provided to the first computing device 100_1.

The first processor 110_1 may perform a first attention operation using the received intermediate value and the previously stored shared key-value cache. The first processor 110_1 may provide the result value according to the first attention operation to outside, as in ②-2.

Alternatively, the result value of the first attention operation and the result value of the second attention operation may be combined and provided externally.

For example, the first processor 110_1 may perform the first attention operation using the received query and the previously stored shared key-value cache. The first intermediate value generated according to the first attention operation may be output externally.

The second processor 110_2 may perform a second attention operation based on the received query and the previously stored user key-value cache or parameters of an artificial intelligence model. A second intermediate value may be generated according to the second attention operation. The second intermediate value may be output externally. As in ③, the first intermediate value output by the first processor 110_1 and the second intermediate value output by the second processor 110_2 may be combined and provided externally.

The method of performing the attention operation separately by the first computing device 100_1 and the second computing device 100_2 and the method of providing the result value according to the attention operation may vary. A plurality of computing devices 100 may be used for the attention operation, and each of the plurality of computing devices 100 may operate for the first attention operation or the second attention operation.

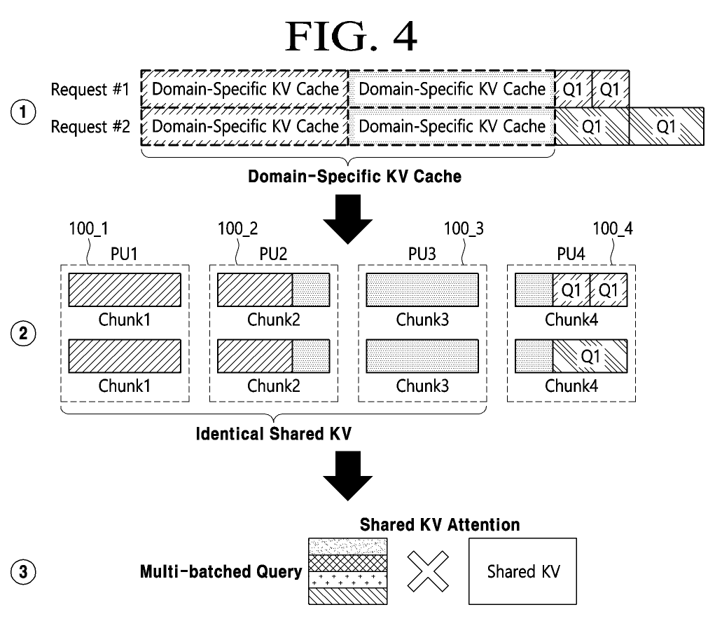

FIG. 4 illustrates an example of a method of performing an operation using an artificial intelligence model performed by a computing system according to embodiments of the present disclosure.

Referring to FIG. 4, a computing system including a plurality of computing devices 100 may receive a query and perform an inference operation using an artificial intelligence model. FIG. 4 exemplarily illustrates a case where the computing system includes four computing devices 100_1, 100_2, 100_3, and 100_4. Each of the four computing devices 100_1, 100_2, 100_3, and 100_4 may be referred to as a processing unit (PU).

The computing system may receive Request #1 and Request #2 as queries, as in ①. The computing system may perform an inference operation on Request #1 and Request #2. The computing system may use a key-value cache required for the inference operation. The key-value cache may include a shared key-value cache and a user key-value cache.

A shared key-value cache can be considered a domain-specific key-value cache. In FIG. 4, a user key-value cache for each query may be represented as Q1.

An attention operation using the shared key-value cache may be performed for Request #1 and Request #2. An attention operation using the shared key-value cache, which is a domain-specific key-value cache, may be performed by some computing devices 100 included in the computing system. The shared key-value cache may be stored in a single computing device 100 or may be divided and stored across a plurality of computing devices 100.

For example, as illustrated in the example shown in ②, a shared key-value cache may be stored in the first computing device 100_1. The shared key-value cache stored in the first computing device 100_1 may correspond to a single specific field.

A shared key-value cache may be stored in the second computing device 100_2. The shared key-value cache stored in the second computing device 100_2 may be a shared key-value cache corresponding to two specific fields. For example, a shared key-value cache corresponding to a first field and a shared key-value cache corresponding to a second field may be stored in the second computing device 100_2. The first field may be a field corresponding to the shared key-value cache stored in the first computing device 100_1. The shared key-value cache corresponding to the first field may be stored in the first computing device 100_1 and the second computing device 100_2.

Similarly, a shared key-value cache corresponding to the second field may be stored in the second computing device 100_2 and the third computing device 100_3. All of the shared key-value caches stored in the third computing device 100_3 may correspond to the second field. Additionally, a portion of the shared key-value cache corresponding to the second field may be stored in the fourth computing device 100_4.

The fourth computing device 100_4 may store a portion of the shared key-value cache corresponding to the second field. Additionally, the fourth computing device 100_4 may store a user key-value cache generated according to a query. The computing device 100 storing the user key-value cache may be separate from the computing device 100 storing the shared key-value cache. In some cases, the shared key-value cache and the user key-value cache may be stored in the same computing device 100, as in the fourth computing device 100_4 illustrated in FIG. 4.

The first computing device 100_1, the second computing device 100_2, and the third computing device 100_3 of the computing system may perform an attention operation using an input query and a previously stored shared key-value cache. The first attention operation using the shared key-value cache may be performed by three computing devices 100.

A portion of the first attention operation using the shared key-value cache may be performed by the fourth computing device 100_4. Additionally, a second attention operation using a user key-value cache may be performed by the fourth computing device 100_4. The fourth computing device 100_4 may perform the second attention operation using an input query and parameters of a pre-stored artificial intelligence model and generate a user key-value cache. The fourth computing device 100_4 may perform the second attention operation using the query and the generated user key-value cache. The fourth computing device 100_4 may output an intermediate value or a result value according to the second attention operation.

The first attention operation using a shared key-value cache may be performed by some of the first computing device 100_1, the second computing device 100_2, the third computing device 100_3, and the fourth computing device 100_4. A second attention operation using a user key-value cache may be performed by some of the fourth computing devices 100_4.

As shown in the example in ③, since the first attention operation using the shared key-value cache is performed by the computing device 100, the first attention operation using the shared key-value cache may be performed simultaneously for a plurality of queries. The first attention operation using the shared key-value cache may be efficiently performed by some of the computing devices 100 among the plurality of computing devices 100 included in the computing system. In an embodiment, the simultaneous processing may be achieved by batching query vectors from multiple queries and computing attention against the shared key-value cache in a single batched operation. This multi-batch approach amortizes the cost of accessing the shared key-value cache across multiple queries, thereby increasing throughput compared to processing each query independently.

The computing devices 100 on which the first attention operation using the shared key-value cache and the second attention operation using the user key-value cache are performed may be distinguished, thereby increasing the efficiency of the attention operation using the key-value cache.

Furthermore, since the fields corresponding to the shared key-value cache may vary, the computing system may provide a function for routing the query to an appropriate computing device 100 depending on the field corresponding to the input query.

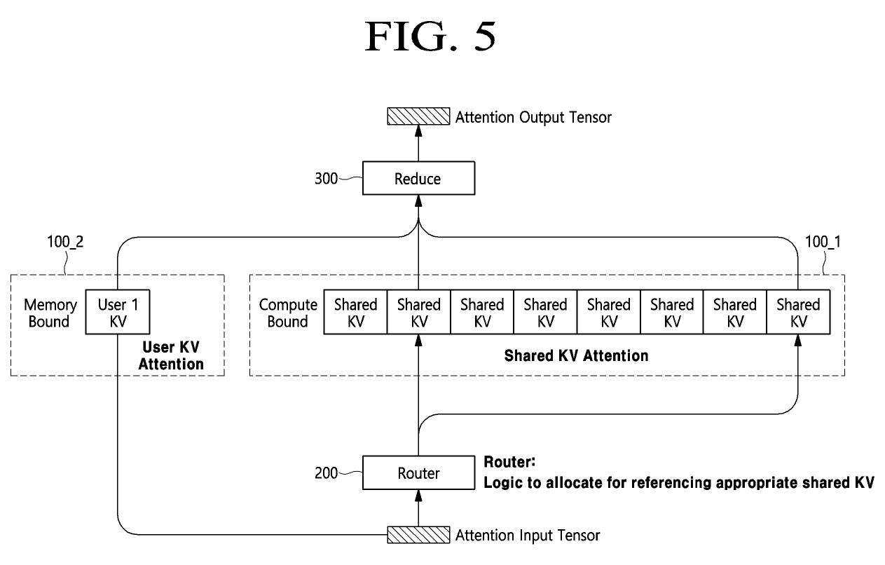

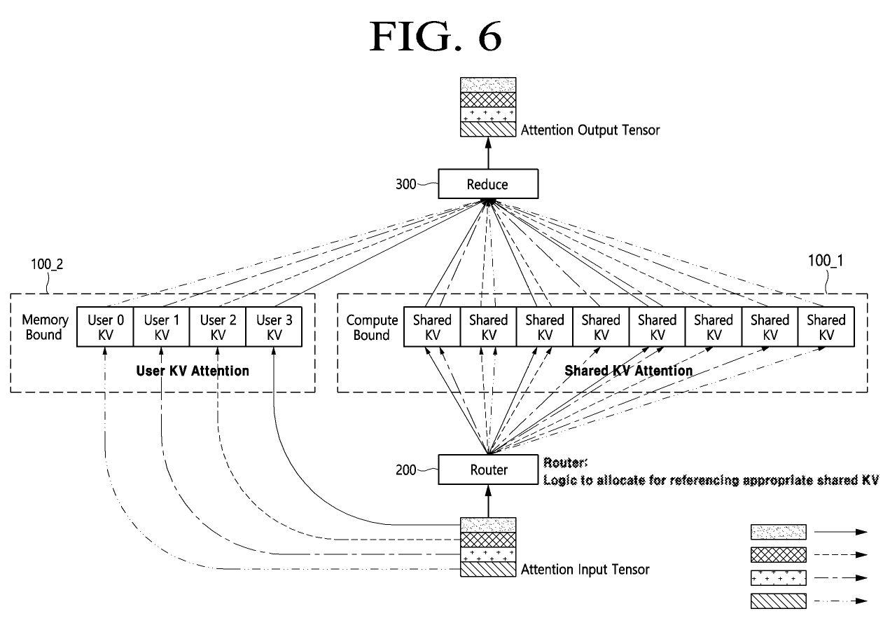

FIGS. 5 and 6 illustrate examples of the operation of the computing system according to the operation method illustrated in FIG. 4.

Referring to FIG. 5, the computing system may include a first computing device 100_1. The first computing device 100_1 may store a shared key-value cache. As in the example illustrated in FIG. 4, shared key-value caches corresponding to different fields may be stored in each computing device 100, or shared key-value caches corresponding to two or more fields may be stored in a single computing device 100.

FIG. 5 illustrates an example in which a shared key-value cache corresponding to a plurality of fields is stored in the first computing device 100_1. However, a shared key-value cache corresponding to each field may also be stored in a separate first computing device 100_1. The first computing device 100_1 may have computational performance suitable for performing operations using the shared key-value cache.

The computing system may include a second computing device 100_2. The second computing device 100_2 may store a user key-value cache. The user key-value cache may be a key-value cache generated according to an attention operation performed based on an input query. The user key-value cache may be used when performing an operation on an intermediate value generated using subsequent query or the shared key-value cache.

The second computing device 100_2 may include a second memory 120_2 with a high bandwidth that communicates with a second processor 110_2 included in the second computing device 100_2 to be suitable for performing an operation using user key-value caches.

The computing system may transmit the received query to the first computing device 100_1 and the second computing device 100_2. The computing system may include a router 200 that distributes the received query to one of the first computing devices 100_1. The router 200 or a logic circuit controlling the router 200 may determine which field the received query corresponds to. The router 200 may transmit the received query to the first computing device 100_1 that stores a shared key-value cache included in the field corresponding to the received query.

For example, as illustrated in FIG. 5, a received query may be forwarded to a first computing device 100_1 that stores a shared key-value cache corresponding to two fields among a plurality of shared key-value caches included in the first computing device 100_1, or to a first processor 110_1 within the first computing device 100_1.

A query received by the router 200 may be forwarded to a computing device 100 that stores a shared key-value cache corresponding to the field related to the query. The first computing device 100_1 may perform an attention operation based on the received query and the shared key-value cache, and output an intermediate value or result value generated according to the attention operation.

The received query may be forwarded to a second computing device 100_2 that performs an operation based on a user key-value cache. The second computing device 100_2 may perform an attention operation based on the received query and the user key-value cache generated according to the query. The second computing device 100_2 may output an intermediate value or result value generated according to the attention operation.

The computing system may include a result output module 300 that combines the intermediate value or result value output by the first computing device 100_1 and the intermediate value or result value output by the second computing device 100_2. The result output module 300 may output a final result value by combining a value received from the first computing device 100_1 and a value received from the second computing device 100_2, for example as a sum Alternatively, the result output module 300 may combine the values using a weighted sum, where weights are determined based on the query and/or a learned gating function.

In addition, in some cases, since an attention operation using a shared key-value cache is performed by the first computing device 100_1, attention operations for multiple queries may be performed simultaneously, thereby increasing the efficiency of the attention operation.

As an example, referring to FIG. 6, the computing system may include a first computing device 100_1, a second computing device 100_2, a router 200, and a result output module 300.

The router 200 may transmit a query to the first computing device 100_1 that stores a shared key-value cache corresponding to the received query. The first computing device 100_1 to which each query is transmitted may be selected independently for each query. At least two of the plurality of queries may be transmitted to the first computing device 100_1 that stores the same shared key-value cache. The router 200 may identify a group including the shared key-value cache corresponding to each of the plurality of queries, and if a preset number of queries corresponding to the shared key-value cache included in the same group are received, then the router 200 may transmit the preset number of queries simultaneously to the first computing device 100_1. In an embodiment, the group may be defined based on a domain field, shared key-value cache chunk identity, or a combination thereof. The preset number may be selected based on a batch size that optimizes throughput for the first computing device 100_1 in view of memory capacity, computational throughput, and latency requirements (e.g., 8, 16, 32, or another value).

An attention operation based on the shared key-value cache may be performed simultaneously for two or more queries.

The plurality of queries may be transmitted to the second computing device 100_2. An attention operation may be performed by the second computing device 100_2 for the plurality of queries.

The second computing device 100_2 may perform an attention operation based on a user key-value cache. The user key-value cache may be a key-value cache corresponding to each of the plurality of queries. For each of the plurality of queries, an operation based on the parameters of the artificial intelligence model may be performed, and a user key-value cache may be generated. An attention operation may be performed on the generated user key-value cache and the query, and an intermediate value or result value may be output.

Since the attention operation is performed based on a separate user key-value cache for each query, the second computing device 100_2 may sequentially perform the attention operation for the plurality of queries.

The result output module 300 may output a final result value by combining the intermediate value or result value output by the first computing device 100_1 and the intermediate value or result value output by the second computing device 100_2. Since attention operations using a shared key-value cache can be performed simultaneously for a plurality of queries, the efficiency of attention operations using a shared key-value cache can be improved.

In this way, attention operations using different types of key-value caches can be performed by the first computing device 100_1 and the second computing device 100_2 included in the computing system, thereby improving the operating performance of the computing system performing the attention operations.

The computing system may include a plurality of first computing devices 100_1 and a plurality of second computing devices 100_2, and the plurality of first computing devices 100_1 and the plurality of second computing devices 100_2 may constitute a computing node.

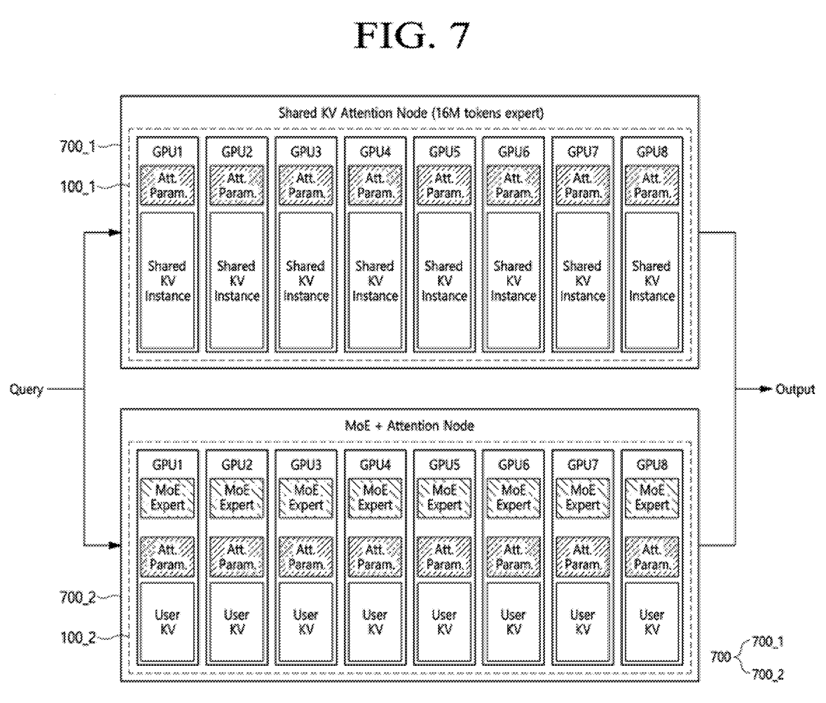

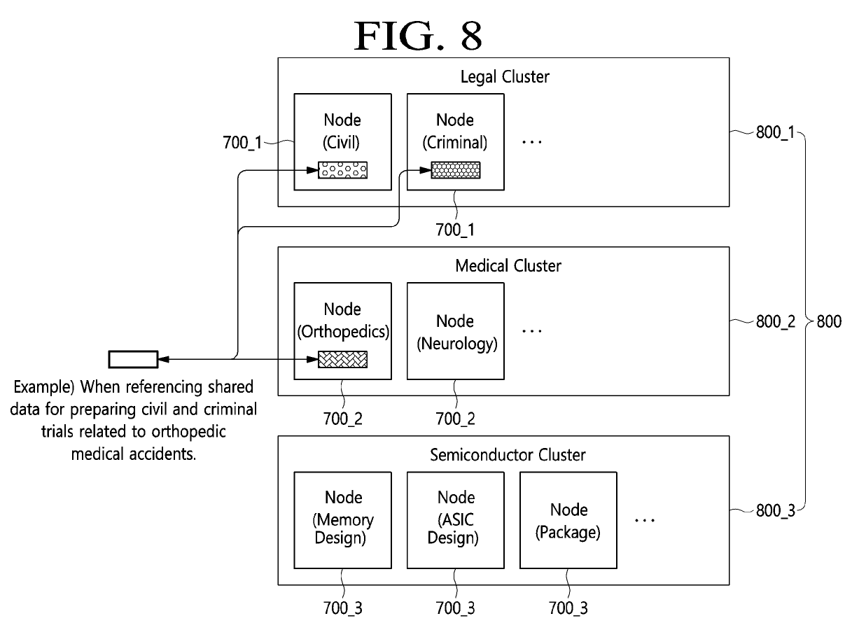

FIGS. 7 and 8 illustrate other examples of schematic configurations of computing systems according to embodiments of the present disclosure.

Referring to FIG. 7, the computing system may include a plurality of computing nodes 700. For example, the computing system may include a first computing node 700_1 and a second computing node 700_2.

The first computing node 700_1 may include a plurality of first computing devices 100_1. Each of the plurality of first computing devices 100_1 may, for example, include a graphics processing unit. The first computing node 700_1 may be referred to as a shared key-value attention node or a public key-value attention node. The first computing node 700_1 processes attention operations using the shared key-value cache and may be configured with computing devices selected to improve throughput for multi-batch shared key-value attention.

The second computing node 700_2 may include a plurality of second computing devices 100_2. Each of the plurality of second computing devices 100_2 may, for example, include a graphics processing unit. The second computing node 700_2 may be referred to as an expert mixed attention node or a user key-value attention node. The second computing node 700_2 processes attention operations using user key-value caches and may be configured with computing devices selected to improve throughput for user-specific attention operations, which may be memory bound. In some embodiments, the second computing node 700_2 may also perform feed-forward network (FFN) operations and other per-token computations in the transformer inference pipeline.

Each of the plurality of first computing devices 100_1 included in the first computing node 700_1 may store an attention parameter. The attention parameter may be a parameter set for an artificial intelligence model and used for attention operation. Each of the plurality of first computing devices 100_1 may store a shared key-value cache.

Each of the plurality of second computing devices 100_2 included in the second computing node 700_2 may store an attention parameter. The attention parameter stored in the second computing device 100_2 may be identical to the attention parameter stored in the first computing device 100_1, but is not limited thereto. Each of the plurality of second computing devices 100_2 may store a user key-value cache. In an embodiment, storing identical attention parameters in the first computing node 700_1 and the second computing node 700_2 may allow both nodes to perform attention operations using the same underlying model, while using different key-value caches for shared domain knowledge and user-specific context.

The first computing node 700_1 may perform an attention operation on a received query using an attention parameter and a shared key-value cache. The first computing node 700_1 may output a result value according to the attention operation performed based on the shared key-value cache.

The second computing node 700_2 may perform an attention operation on a received query using an attention parameter and a user key-value cache. The second computing node 700_2 may output a result value according to the attention operation performed based on the user key-value cache.

The result values output by the first computing node 700_1 and the second computing node 700_2 may be combined and output as a final result value. Alternatively, in some cases, the result values output by the first computing node 700_1 and the second computing node 700_2 may be transmitted to another node to perform an operation.

For example, the result value performed by the first computing node 700_1 may be transmitted to the second computing node 700_2. The second computing node 700_2 may perform an attention operation applying a user key-value cache on the result value received from the first computing node 700_1 and output a final result value.

Alternatively, the result value performed by the second computing node 700_2 may be transmitted to the first computing node 700_1. The first computing node 700_1 may perform an attention operation applying a shared key-value cache on the result value received from the second computing node 700_2 and output a final result value.

An attention operation using a shared key-value cache and an attention operation using user key-value caches may be performed by separate computing nodes. The result values from the attention operations performed on separate computing nodes may be combined and output, or they may be transmitted to another computing node, and an attention operation may be performed on the transmitted result values and a result value of the attention operation may be output.

FIG. 7 exemplarily illustrates a computing system including two computing nodes 700, but the computing system may also include three or more computing nodes 700. There may be a plurality of computing nodes 700 storing a shared key-value cache.

In this case, a result value may not be transmitted or received between computing nodes 700 storing the shared key-value cache. The result values computed by the computing node 700 storing the shared key-value cache may be transmitted to computing node 700 that perform an attention operation using a user key-value cache.

A shared key-value cache corresponding to each field may be stored and utilized in separate computing nodes 700. Additionally, a computing nodes 700 storing a shared key-value cache corresponding to similar fields may form a group and be utilized for an attention operation.

For example, referring to FIG. 8, the computing system may include a plurality of computing node groups 800. The computing node groups 800 may also be referred to as a computing node cluster.

As shown in the example illustrated in FIG. 8, the computing system may include a first computing node group 800_1, a second computing node group 800_2, and a third computing node group 800_3.

The first computing node group 800_1 may include, for example, a plurality of first computing nodes 700_1 that store a shared key-value cache related to law or legal issues. Each of the plurality of first computing nodes 700_1 may store a shared key-value cache related to law or legal issues and corresponding to a different field.

The second computing node group 800_2 may include, for example, a plurality of second computing nodes 700_2 that store shared key-value caches related to healthcare or medical treatment. Each of the second computing nodes 800_2 may store shared key-value caches related to healthcare or medical treatment and corresponding to different fields.

The third computing node group 800_3 may include, for example, a plurality of third computing nodes 700_3 that store a shared key-value cache related to semiconductors. Each of the third computing nodes 700_3 may store a shared key-value cache related to semiconductors and corresponding to different fields.

When performing an attention operation using an artificial intelligence model on an input query, the computing system may identify a field corresponding to the query and select a computing node group 800 or a computing node 700 included in the computing node group 800 to which the query will be forwarded.

For example, if the input query is "referencing shared data for preparing civil and criminal trials related to orthopedic medical accidents", the computing system may select the legal field and the medical field as the fields corresponding to the query.

The computing system may forward the input query to the first computing node 700_1 that stores a shared key-value cache related to civil cases and the first computing node 700_1 that stores a shared key-value cache related to criminal cases in the first computing node group 800_1 related to the legal field. An attention operation may be performed on the shared key-value cache stored in each of the two first computing nodes 700_1.

Furthermore, the computing system may forward an input query to a second computing node 700_2 that stores a shared key-value cache related to orthopedics. An attention operation can be performed based on the shared key-value cache stored in one second computing node 700_2 in a second computing node group 800_2 related to the medical field.

An intermediate value or result value resulting from the attention operation performed using the shared key-value cache may be output by each computing node group 800.

The computing system may output a final result value by combining the result value resulting from the operation performed by a separate computing node 700 or separate computing node group 800 that performs the attention operation based on the user key-value cache and the result value resulting from the attention operation using the shared key-value cache.

The computing system may improve the computational efficiency of attention operations based on shared key-value caches by configuring a computing device 100 that performs an attention operation using a shared key-value cache into a separate computing node 700 or separate computing node group 800 for each field and performing the attention operation.

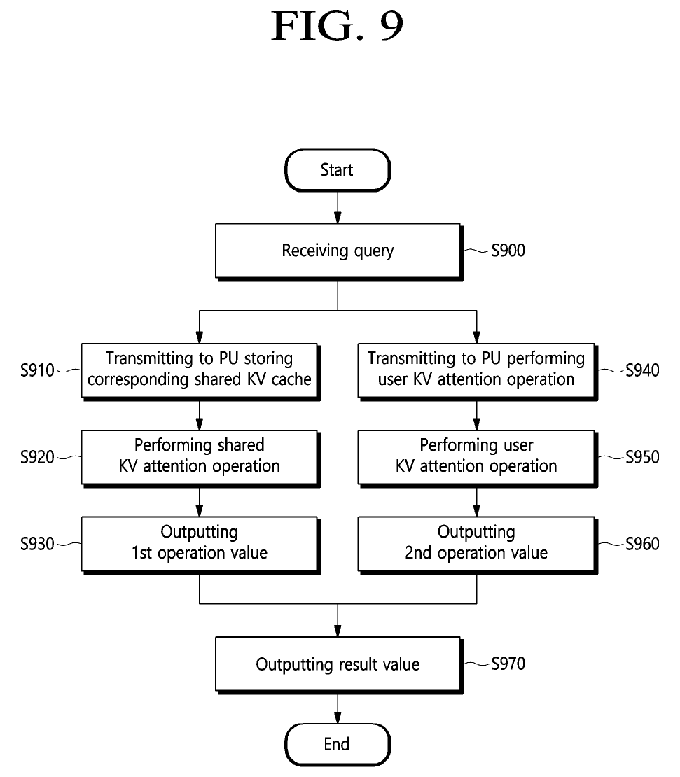

FIG. 9 illustrates an example of an operating method of a computing system according to embodiments of the present disclosure.

Referring to FIG. 9, the computing system can receive a query from an external source (S900).

The computing system may identify a field corresponding to the query. The computing system may transmit or forward the query to a computing device 100 or processing unit that stores a shared key-value cache belonging to the field corresponding to the query (S910).

The computing device 100 storing a shared key-value cache may perform an attention operation based on an input query and a previously stored shared key-value cache (S920). The computing device 100 may output a first operation value generated according to the attention operation (S930).

The computing system may transmit or forward the query to a computing device 100 that performs an attention operation based on a user key-value cache (S940).

The computing device 100 may perform an attention operation based on a query and a user key-value cache (S950). The user key-value cache may be a value generated based on an operation performed using the query and parameters of a pre-stored artificial intelligence model. The computing device 100 may output a second operation value based on the operation performed based on the user key-value cache (S960).

The computing system may output a result value based on a first operation value generated based on an attention operation performed based on a shared key-value cache and a second operation value generated based on an attention operation performed based on the user key-value cache (S970). The result value may be a value output by combining the first operation value and the second operation value. Alternatively, the first operation value or the second operation value may be transmitted to another computing device 100 and may be a value output based on an operation performed based on the transmitted operation value.

In the computing system according to the embodiments of the present disclosure, when performing an attention operation according to an input query, a device or unit performing an attention operation using a shared key-value cache and a device or unit performing an attention operation using a user key-value cache are distinguished from each other, thereby increasing the efficiency of the attention operation using the shared key-value cache and improving the operating performance of the computing system performing the attention operation.

Although various embodiments of the disclosed technology have been described with particular specifics and varying details for illustrative purposes, those skilled in the art will appreciate that various modifications, additions and substitutions may be made based on what is disclosed or illustrated in the present disclosure. The following paragraphs describe additional exemplary embodiments relating to sparse attention over the shared key-value cache.

In an alternative embodiment, the computing system may implement sparse attention over the shared key-value cache to reduce computational cost. This approach, referred to as mixture of shared key-value attention (MoSKA), organizes the shared key-value cache into a plurality of cache chunks and selects a subset of cache chunks for each query rather than performing attention over the entire shared key-value cache. For example, a shared key-value cache representing 16 million tokens may be divided into eight cache chunks of approximately 2 million tokens each, and the first attention operation may be performed using one or more selected cache chunks. In some implementations, the first attention operation is performed using only the selected cache chunks.

The computing system may include a chunk selector that selects cache chunks relevant to a received query. The chunk selector may perform selection based on similarity between an embedding derived from the query and embeddings representing cache chunks, classification of the query into topic categories corresponding to cache chunks, and/or learned routing functions. The first processor 110_1 may perform the first attention operation using the query and key vectors and value vectors contained in the selected cache chunks. Cache chunks that are not selected need not be accessed, thereby reducing computational cost.

The cache chunks may be coarse-grained, with each cache chunk representing a large number of tokens (e.g., about 1-4 million tokens) to reduce routing overhead and minimize selection errors. The chunk selector may select different numbers of cache chunks depending on query scope and may select a minimum number of cache chunks to ensure baseline shared knowledge availability. In multi-node configurations, MoSKA may operate hierarchically by selecting computing nodes that store relevant shared key-value caches and then selecting cache chunks within the selected computing nodes.

Embodiment 1: a computing system comprises a first computing node configured to store at least one shared key-value cache shared among a plurality of queries associated with different user sessions, perform a first attention operation based on a received query and the at least one shared key-value cache, and output a first operation value calculated according to the first attention operation; and a second computing node configured to store a user key-value cache generated according to the received query, perform a second attention operation based on at least one of the received query or the first operation value and the user key-value cache, and provide a second operation value calculated according to the second attention operation.

Embodiment 21, in the computing system of embodiment 1, the at least one shared key-value cache comprises a plurality of cache chunks, and wherein the first computing node includes a chunk selector configured to select one or more cache chunks from the plurality of cache chunks based on the query, and wherein the first attention operation is performed using the query and the selected one or more cache chunks.

Embodiment 22, in the computing system of embodiment 21, each of the plurality of cache chunks comprises key vectors and value vectors corresponding to between one million and four million tokens.

Embodiment 23, in the computing system of embodiment 21, wherein the chunk selector selects the one or more cache chunks based on a similarity between an embedding derived from the query and embeddings representing content of the plurality of cache chunks.

Embodiment 18: an operating method of a computing system, comprising: receiving a query; performing a first attention operation based on the query and a shared key-value cache by a first processing unit storing the shared key-value cache shared among a plurality of queries associated with different user sessions, and outputting a first operation value; and performing a second attention operation based on the first operation value and a user key-value cache by a second processing unit storing the user key-value cache generated according to the query and outputting a second operation value.

Embodiment 24: The operating method of Embodiment 18, further comprising: selecting one or more cache chunks from a plurality of cache chunks comprising the shared key-value cache based on the query, wherein performing the first attention operation comprises performing the first attention operation using the query and the selected one or more cache chunks.

The foregoing description of the embodiments has been provided for purposes of illustration and description. It is not intended to be exhaustive or to limit the disclosed technology to the precise forms disclosed. Many modifications and variations will be apparent to those skilled in the art in view of the above disclosure. The scope of the disclosed technology is intended to be defined by the appended claims and their equivalents.

What is claimed is:

1. A computing system comprising:
a first computing node configured to store at least one shared key-value cache shared among a plurality of queries associated with different user sessions, perform a first attention operation based on a received query and the at least one shared key-value cache, and output a first operation value calculated according to the first attention operation; and
a second computing node configured to store a user key-value cache generated according to the received query, perform a second attention operation based on at least one of the received query or the first operation value and the user key-value cache, and provide a second operation value calculated according to the second attention operation.

2. The computing system of claim 1, wherein the first computing node includes:
a plurality of first memories storing the at least one shared key-value cache that is stored separately according to a group corresponding to the query; and
a plurality of first processors that perform the first attention operation using the at least one shared key-value cache in response to receiving the query.

3. The computing system of claim 2, wherein the first attention operation for the query is performed by the remaining first processors excluding at least one first processor among the plurality of first processors, the at least one first processor being configured to perform at least one of routing, scheduling, or cache management.

4. The computing system of claim 2, wherein the second computing node includes:
a plurality of second processors that generate the user key-value cache based on the query upon receiving the query; and
a plurality of second memories that store the user key-value cache generated by the plurality of second processors.

5. The computing system of claim 4, wherein a computational performance value of each of the plurality of first processors is greater than a computational performance value of each of the plurality of second processors, and a bandwidth of each of the plurality of second memories is greater than or equal to a bandwidth of each of the plurality of first memories.

6. The computing system of claim 4, wherein each of the plurality of first processors performs the first attention operation on two or more queries simultaneously using the two or more queries and the at least one shared key-value cache.

7. The computing system of claim 4, wherein each of the plurality of second processors sequentially performs the second attention operation for each of two or more queries.

8. The computing system of claim 4, further comprising a router that receives the query, selects at least one first processor among the plurality of first processors to perform the first attention operation for the query, and transmits the query to the selected at least one first processor.

9. The computing system of claim 1, wherein the at least one shared key-value cache comprises a plurality of cache chunks, and wherein the first computing node includes a chunk selector configured to select one or more cache chunks from the plurality of cache chunks based on the query, and wherein the first attention operation is performed using the query and the selected one or more cache chunks.

10. The computing system of claim 1, further comprising:
a third computing node that stores at least one shared key-value cache different from the at least one shared key-value cache stored in the first computing node, receives the query and performs a third attention operation based on the query and the at least one shared key-value cache stored in the third computing node, and outputs a third operation value calculated according to the third attention operation.

11. The computing system of claim 1, wherein the first computing node receives the second operation value from the second computing node and performs the first attention operation based on the second operation value and the at least one shared key-value cache.

12. The computing system of claim 1, wherein the first computing node stores a first attention parameter used when performing the first attention operation, and the second computing node stores a second attention parameter used when performing the second attention operation,
wherein the first attention parameter is the same as the second attention parameter.

13. A computing device comprising:
a first processing unit including a first memory that stores at least one shared key-value cache shared among a plurality of queries associated with different user sessions and a first processor that performs a first attention operation based on a received query and the at least one shared key-value cache and outputs a first operation value; and
a second processing unit including a second memory that stores a user key-value cache generated according to the received query and a second processor that receives the first operation value and performs a second attention operation based on the first operation value and the user key-value cache to provide a second operation value.

14. The computing device of claim 13, wherein the first processing unit performs the first attention operation on two or more queries simultaneously, and the second processing unit sequentially performs the second attention operation on the two or more queries.

15. The computing device of claim 13, further comprising a third processing unit including a third memory that stores at least one shared key-value cache different from the at least one shared key-value cache stored in the first memory and a third processor that performs a third attention operation based on the query and the at least one shared key-value cache stored in the third memory to provide a third operation value.

16. The computing device of claim 15, wherein the first operation value and the third operation value are transmitted to the second processing unit via one or more communication links.

17. An operating method of a computing system, comprising:
receiving a query;
performing a first attention operation based on the query and a shared key-value cache by a first processing unit storing the shared key-value cache shared among a plurality of queries associated with different user sessions, and outputting a first operation value; and
performing a second attention operation based on the first operation value and a user key-value cache by a second processing unit storing the user key-value cache generated according to the query and outputting a second operation value.

18. The operating method of claim 17, wherein the first attention operation for a plurality of queries is performed simultaneously by the first processing unit, and the second attention operation for the plurality of queries is performed sequentially by the second processing unit.

19. The operating method of claim 17, wherein the receiving a query includes identifying a group including the shared key-value cache corresponding to the query, and, if a preset number of queries corresponding to the shared key-value cache included in the same group are received, transmitting the preset number of queries simultaneously to the first processing unit.

20. The operating method of claim 17, further comprising:
selecting one or more cache chunks from a plurality of cache chunks comprising the shared key-value cache based on the query, wherein performing the first attention operation comprises performing the first attention operation using the query and the selected one or more cache chunks.
